(19) United States
(12) Patent Application Publication
(10) Pub. No.: US 2014/0254133 A1
(43) Pub. Date: Sep. 11, 2014

(54) PHOSPHOR WHEEL, METHOD FOR PRODUCING A PHOSPHOR WHEEL AND LIGHTING ARRANGEMENT

(71) Applicants: Stefan Kotter, Augsburg (DE); Dirk Berben, Herdecke (DE)

(72) Inventors: Stefan Kotter, Augsburg (DE); Dirk Berben, Herdecke (DE)

(73) Assignee: OSRAM GMBH, Muenchen (DE)

(21) Appl. No.: 14/351,881

(22) PCT Filed: Sep. 14, 2012
(86) PCT No.: PCT/EP2012/068172

§ 371 Date: Apr. 15, 2014

(30) Foreign Application Priority Data
Oct. 21, 2011 (DE) 10 2011 084 961.0

(51) Int. Cl. F21V 14/08

(52) U.S. Cl. CPC F21V 14/08
USPC 362/84; 362/317; 29/428

(57) ABSTRACT

The invention relates to a phosphor wheel comprising a carrier (16) and a plurality of pre-manufactured, individual, jointed segments (20) that are mounted on the carrier (16). At least a few of the segments (20) comprise a luminescent substance.

### RELATED APPLICATIONS

The present application is a national stage entry according to 35 U.S.C. §371 of PCT application No.: PCT/EP2012/068172 filed on Sep. 14, 2012, which claims priority from German application No.: 10 2011 084 961.0 filed on Oct. 21, 2011, and is incorporated herein by reference in its entirety.

### TECHNICAL FIELD

Various embodiments relate to a phosphor wheel having segments which have phosphor. Further, various embodiments relate to a method for producing the phosphor wheel and to a lighting arrangement which has the phosphor wheel.

### BACKGROUND

Nowadays, in modern lighting devices, use is increasingly being made of energy-efficient and high-intensity light sources such as LEDs (light emitting diodes) or lasers, normally in the form of laser diodes. As distinct from an incandescent lamp, which is a thermal emitter, these light sources emit light in a narrowly limited spectral range, so that their light is virtually monochromatic. One possible way of opening up further spectral ranges consists, for example, in light conversion, in which phosphors are irradiated by means of LEDs and/or laser diodes and, as a result of the wavelength conversion occurring in the phosphor, in turn emit light of another wavelength. In so-called “remote-phosphor” applications, for example, a layer containing luminous material, for example phosphor, located at a distance from a light source is illuminated, usually by means of LEDs or laser diodes and, in turn, emits light of a different color, i.e. another wavelength. For example, this technique can be used, by using light from blue LEDs by means of admixing yellow light, which is generated by exciting a layer containing luminous material, for example phosphor, with the blue light, to generate corresponding mixed light, for example white light.

For remote-phosphor applications, thin phosphor layers such as cubic silicate minerals, orthosilicates, garnets or nitrides are applied to surfaces of appropriate carriers. The phosphor layers are in this case normally fixed mechanically with binders and attached to an optical system (lenses, collimators, etc.), wherein the light coupling can be carried out, for example, via air or by means of an immersion medium. In order to ensure the most optimal optical attachment of the optical system to the phosphor and to avoid light losses, the most direct optical attachment possible should be ensured.

In the aforementioned applications, the phosphors are usually excited into emission by means of LEDs and/or laser diodes with high luminous powers. The thermal losses produced in the process have to be dissipated, for example via the carrier, in order to avoid overheating and therefore thermally induced changes of the optical properties or else the destruction of the phosphor. Current methods for circumventing this problem consist in the use of a color wheel as carrier, which is coated with the phosphor, or in limiting the luminous power with which the phosphor layers are irradiated. Phosphor layers are distributed on the color wheel, and the color wheel is rotated under an illuminating beam, so that, with the color wheel rotating, the various phosphor layers of an annular path are irradiated sequentially over time, which preserves each individual region and therefore the phosphor layers overall.

Without any additional use of binders, for example silicones, the phosphors, which are normally present in powder form, do not form any mechanically stable layers, i.e. no abrasion-resistant and/or scratch-resistant layers or layers without adequate adhesion, for example with respect to the centrifugal force that acts during operation or with respect to vibrations that occur during operation. However, binders are also used generally in order to combine the phosphor particles into a phase which can then be applied to appropriate surfaces. Known as alternatives are converter elements, which are formed from a ceramic encompassing the phosphor or of a crystal encompassing the phosphor.

When a phosphor wheel is used in a lighting arrangement, for example a projector or another arrangement in which a high luminous density is required, one difficulty consists in providing the relatively large-area phosphor wheel uniformly and homogeneously with a phosphor layer, or in producing an appropriate phosphor wheel from ceramic.

### SUMMARY

In various embodiments, a phosphor wheel and a method for producing a phosphor wheel are provided, wherein, for example, a production process can be simplified and in this way a relatively high quality can be made possible with low production costs and few rejects. Furthermore, in various exemplary embodiments, a lighting arrangement in which the phosphor wheel is produced with relatively high quality with low costs is provided.

In various embodiments, a phosphor wheel is provided. The phosphor wheel includes a carrier and a multiplicity of individual segments which are prefabricated, joined together and then applied to the carrier. At least some of the segments have phosphor.

Forming the phosphor wheel from individual segments cohering via the carrier makes it possible to produce the individual segments and therefore the phosphor wheel simply and economically. In particular, a plurality of the segments can be produced by their being separated from a piece of material that can be handled simply and produced simply. The fact that the individual segments are joined together means that, before the joining together, the segments are individual parts that are bodily independent of one another which, although they can be fabricated together, can then be separated, and that the segments are then fixed on the carrier and thus connected to one another again via the carrier. In other words, the segments are prefabricated and then the prefabricated segments are joined together with the carrier to form the actual phosphor wheel.

According to various embodiments, the segments are formed and joined together such that at least one segment of a circular path extends over a plurality of adjacent segments. The circular path can, for example, be representative of a light path over which, during operation of the phosphor wheel, a light beam runs on the phosphor wheel when the latter is irradiated with the light beam and the phosphor wheel is rotated. This has the effect that, despite the segmented formation of the segments, during operation the light beam is able to irradiate the phosphor continuously and thus the phosphor wheel can emit light continuously.

According to various embodiments, the segments have a polygonal structure. The polygonal structure can contribute simply to the fact that the segments can be separated from the piece of material simply and without much waste and, following the separation and application of the segments to the carrier, the segment of the circular path, for example of the light beam, extends over a plurality of adjacent segments.

According to various embodiments, the segments have a triangular or a trapezoidal structure. The triangular or trapezoidal structure can contribute in a particularly simple way to the segments joined together forming a substantially closed surface, to the segments forming a circular path on the carrier and, during the production, to barely any waste being produced. An outer surface of the segments can be formed to be planar in at least some of the segments.

According to various embodiments, the segments joined together form at least one segment of a ring. This advantageously contributes to the light beam sweeping over one or more segments of a circular path running over the segments during the rotation of the phosphor wheel. Furthermore, the segments joined together can form a ring.

A central angle of the segments can, for example, lie in an angular range between 3° and 45°, in particular in an angular range between 5° and 15°. For instance, the central angle can be 6°. The smaller the central angle, the more individual segments are needed. The use of relatively small segments with relatively small central angles contributes to the fact that, given a polygonal structure of the segments, the segments overall are able to form segments of a ring to a good approximation, only relatively little waste arising during the production of the segments. A lower limit for the size of the segments and their central angles is formed by the manageability and stability of the individual segments.

According to various embodiments, a first group of the segments has a first phosphor, which is suitable to generate light of a first color. A second group of the segments has a second phosphor, which is suitable to generate light of a second color, which differs from the first color. In this way, with the aid of the phosphor wheel, light of two different colors can be generated.

According to various embodiments, a third group of the segments has a third phosphor, which is suitable to generate light of a third color, which differs from the first and second color. In this way, with the aid of the phosphor wheel, light of three different colors can be generated.

According to various embodiments, a fourth group of segments is designed to be reflective. This readily makes it possible to deflect the light from the light source having the appropriate color. Furthermore, if necessary, further groups and/or further segments can be provided.

For instance, a plurality of segments which have the same phosphor are arranged directly beside one another, so that a combined area of the same phosphor, which is larger than the area of one of the segments, is produced on the carrier. A plurality of segments with the same phosphor directly beside one another forms a phosphor section. A plurality of these phosphor sections can be arranged beside one another, wherein the phosphors thereof can differ from one another. Likewise, a plurality of reflective segments can be joined together to form reflective sections and be inserted between two phosphor sections.

According to various embodiments, the segments each have a substrate segment, which is coated with a phosphor layer having the phosphor. This contributes to the segments being able to be produced particularly simply. In particular, a large piece of substrate can be coated and then the coated substrate segments can be separated as finished segments. On a side of the substrate segments that faces away from the phosphor layer, the substrate segments can have metal or can be coated with a metal layer, for example the substrate can have aluminum or tungsten or be formed therefrom and/or it can be coated with a copper and/or chromium layer. This can contribute to fixing the segments to the carrier in a simple way and with good thermal coupling, for example by means of soldering. If the substrate is formed from highly reflective aluminum, then the reflective segments can be produced simply by their not being coated but merely separated.

According to various embodiments, the segments have a ceramic or are formed therefrom. The phosphor is embedded in the ceramic. Segments made of ceramic can have a very high thermal conductivity coefficient, so that large quantities of energy can be introduced into the segments without damaging the segments. Furthermore, the segments then no longer have to be coated with phosphor. The ceramic segments can be coated with a metal layer, similarly to the substrate segments, in order that they can be fixed to the carrier, for example by means of soldering.

According to various embodiments, the segments have a crystal or are formed therefrom. The phosphor is incorporated in the crystal structure of the crystal. Segments made of crystal can have a very high thermal conductivity coefficient, so that large quantities of energy can be introduced into the segments without damaging the segments. Furthermore, the segments then no longer have to be coated with phosphor. The crystal segments can be coated with a metal layer, similarly to the substrate segments, in order that they can be fixed to the carrier, for example by means of soldering.

Alternatively or additionally to the soldering, the segments can, for example, be firmly adhesively bonded to the carrier.

According to various embodiments, the segments have recesses and the carrier has elevations corresponding thereto, so that the elevations of the carrier are arranged in the recesses of the segments. Alternatively or additionally, the segments have elevations and the carrier has recesses corresponding thereto, so that the elevations of the segments are arranged in the recesses of the carrier. When the segments are joined together on the carrier, the elevations engage in the corresponding recesses. This may contribute to arranging the segments quickly, simply and precisely on the carrier. The recesses may be grooves, for example.

Furthermore, the segments can be in bodily contact with the carrier. For example, tin solder or adhesive can only be applied separately and in such a way that other regions are in bodily, therefore direct, contact with one another. For example, adhesive or tin solder can be applied only to the elevations and/or recesses, while the areas of the segments and the carrier without elevation or recess are arranged in bodily contact with one another. This may contribute to particularly good thermal coupling of the segments to the carrier.

According to various embodiments, the carrier has receptacles for the segments and the segments are at least partly arranged in the receptacles. During the production of the phosphor wheel, the finished segments can then simply be laid in the receptacles provided for said segments. Alternatively or additionally to the recesses and elevations, this can contribute to arranging the segments quickly, simply and precisely on the carrier.

The carrier can have copper or aluminum or be formed therefrom. This can contribute to dissipating the heat produced in the segments during operation quickly and effectively via the carrier. Alternatively or additionally, the carrier can have cooling elements, for example cooling ribs and/or cooling lines for a cooling medium.

In various embodiments, a method for producing the phosphor wheel is provided. Here, the carrier and a multiplicity of individual segments are produced. At least some of the segments have phosphor. The segments are applied to the carrier and joined together. Forming the phosphor wheel from individual segments which are joined together on the carrier and are then connected to one another via the carrier makes it possible to produce the individual segments and therefore the phosphor wheel simply and economically.

According to various embodiments, a piece of material is provided and a plurality of the segments is separated from the one piece of material. The piece of material can, for example, be formed in the manner of a strip, in particular from an endless strip. This contributes substantially to the particularly simple and economical production. The segments can, for example, be sawn or cut out of the piece of material, for example with the aid of a laser.

According to various exemplary embodiments, triangular or trapezoidal segments are separated from the piece of material. The triangular or trapezoidal shape of the segments contributes to the fact that little to no trim, therefore waste, arises during the production of the segments from a larger piece of material and that, following the joining together of the segments, there are no to insignificant joints between the segments and, overall, by means of the joined together segments, to a good approximation at least one segment of a ring can be formed.

According to various embodiments, the piece of material has a piece of substrate which, before the separation of the segments, is coated with a phosphor layer having the phosphor. The phosphor layer is applied, for example, by doctoring or a printing process. This contributes to economical and simple production of the segments.

According to various embodiments, the piece of substrate is first applied to a holding body and then sawn or cut such that individual substrate segments continue to cohere via the holding body following the sawing or cutting and in which, subsequently, the substrate segments on the holding body are coated with the phosphor layer and the coated substrate segments are then detached from the holding body and separated as a result. The cutting or sawing of the segments before the coating contributes to the phosphor layer on the segments not being damaged by the sawing or cutting. The temporary connection between the holding body and the piece of substrate can be produced, for example, by means of an adhesive, for example a thermal-release adhesive. During the separation of the segments, this connection is detached again. As an alternative to the coated substrate segments, pieces of ceramic or crystal which have the phosphor can also be connected to the holding body and, after the cutting or sawing, can be detached from the holding body and thus separated.

According to various embodiments, the piece of material having the phosphor before the separation or the individual segments after the separation is/are coated with a metal layer, at least on one side. The coating of the piece of material, for example the piece of substrate, with the metal layer before the separation contributes to the beneficial and simple production process. The metal layer in general can contribute to fixing the segments to the carrier in a straightforward way and ensuring good thermal coupling of the segments to the carrier.

According to various embodiments, the segments are fixed to the carrier via the metal layer, for example by means of soldering or adhesive bonding. This contributes to good thermal dissipation from the segments to the carrier. For example, tin solder can be applied to the piece of material or the piece of substrate before the separation, or to the segments and/or the carrier after the separation, then the separated segments can be joined together on the carrier and the carrier with the segments can be heated in such a way that the tin solder melts and connects the carrier and the segments permanently. As a result, the segments can be fixed to the carrier simply and quickly, good thermal coupling between the segments and the carrier being achieved. As an alternative to this, the segments can be firmly adhesively bonded to the carrier. This permits the segments to be fixed to the carrier in a particularly straightforward way, wherein, given the choice of a suitable adhesive, good thermal coupling between segments and carrier can also be achieved.

According to various embodiments, the piece of material is formed with recesses or elevations and the carrier is formed with elevations or recesses corresponding thereto. Following the separation of the segments, the individual segments are applied to the carrier such that the elevations of the carrier are arranged in the recesses of the segments or, respectively, the elevations of the segments are arranged in the recesses of the carrier. In order to fix the segments to the carrier, tin solder or adhesive can, for example, be applied exclusively to the recesses or the elevations. Alternatively or additionally, receptacles for the segments, in which the segments can be arranged, can be formed in the carrier.

To generate light of different colors, segments having different phosphors can be produced. For example, two or three different pieces of material can be provided with corresponding different phosphors and then two or three different groups of segments can be separated appropriately from the respective pieces of material and applied to the carrier. Alternatively or additionally, reflective segments can also be produced as an addition to the segments, can be separated and applied to the carrier. Furthermore, if necessary, still further different groups of segments can be produced.

In various embodiments, a lighting arrangement is provided which has the phosphor wheel and an excitation source, for example a light source, which irradiates the segments of the phosphor wheel selectively. An excitation source can, for example, have one or more laser light sources and/or one or more LEDs and/or one or more super-luminescent diodes. The excitation source can also have electromagnetic emitters, for example flash lamps, ultraviolet emitters, infrared emitters, x-ray emitters. The excitation source can also have corpuscular emitters, for example ion and/or electron emitters. For instance, a light beam from the light source is aimed at the phosphor wheel and strikes one of the segments. During operation of the lighting arrangement, in which the light source generates pulsed or continuous light, for example, the phosphor wheel rotates, so that the light beam draws a circular path over the phosphor wheel, in particular the segments. Given suitable activation and coordination of rotational speed and angular position of the phosphor wheel with the light pulses, light in different colors can thus be generated with the aid of the phosphor wheel.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a lighting arrangement according to various embodiments;

FIG. 2 shows a phosphor wheel according to various embodiments;

FIG. 3 shows a phosphor wheel according to various embodiments;

FIG. 4 shows a phosphor wheel according to various embodiments;

FIG. 5 shows a phosphor segment according to various embodiments;

FIG. 6 shows a side view of the phosphor segment according to FIG. 5;

FIG. 7 shows a detail of a carrier according to various embodiments;

FIG. 8 shows a detail of a carrier according to various embodiments;

FIG. 9 shows a piece of material according to various embodiments;

FIG. 10 shows a flowchart of a method for producing the phosphor wheel according to various embodiments;

FIG. 11 shows a flowchart of a method for producing the phosphor wheel according to various embodiments; and

FIG. 12 shows a flowchart of a method for producing the phosphor wheel according to various embodiments.

### DETAILED DESCRIPTION

The following detailed description refers to the accompanying drawing that show, by way of illustration, specific details and embodiments in which the disclosure may be practiced.

In the following extensive description, reference is made to the appended drawings, in which, for the purpose of illustration, specific embodiments in which the disclosure can be implemented are shown. From this point of view, directional terminology such as “above”, “below” and so on is used with reference to the orientation of the figure(s) described. Since components of embodiments can be positioned in a number of different orientations, the directional terminology is used for illustration and is in no way restrictive. It goes without saying that other embodiments can be used and structural or logical changes can be made without departing from the protective scope of the present disclosure. It goes without saying that the features of the various exemplary embodiments described herein can be combined with one another if not specifically otherwise specified. The following extensive description is therefore not to be understood in a restrictive sense, and the protective scope of the present disclosure is defined by the appended claims.

Within the context of this description, the term “coupled” is used to describe both a direct or indirect coupling. In the figures, identical or similar elements are provided with identical designations if this is expedient.

FIG. 1 shows a lighting arrangement 10 according to various embodiments having a light source 12, which generates a light beam 14, and having a phosphor wheel. The phosphor wheel has a carrier 16 and a plurality of individual segments 20 fixed to the carrier 16. The carrier 16 is fixed to a shaft 18 such that it can rotate in a direction of rotation 19. The light source 12 is, for example, a laser diode. As an alternative to this, the light source 12 can be a light-emitting diode (LED) or another light source, for example a diffuse light source. The carrier 16 can have a cooling device, for example cooling ribs or cooling lines for a cooling medium. Furthermore, the carrier can be formed as a wheel with or without spokes, for example, and, for example, have a diameter between 20 mm and 50 mm, in particular between 30 mm and 40 mm. The lighting arrangement 10 can also have a plurality of light sources 12.

The light beam 14 is aimed at segments 20 fixed to the carrier 16. In other words, the light source 12 illuminates or irradiates the segments 20. The light source 12 has a predefined spacing from the segments 20 and is thus not in bodily contact with the segments 20. The light beam 14 excites phosphors in the segments 20, so that the segments 20 in turn emit light beams 22. The color of the light beams 22 depends on which segments 20 are illuminated, which in turn depends on a position or angular position of the carrier 16. For example, pulsed light can here be generated with the aid of the light source 12 and coordinated with an angular position and/or rotational speed of the phosphor wheel, for example, a motor for rotating the carrier 16 being activated in order to coordinate the angular position or the rotational speed. A rotational frequency of the carrier 16 can be, for example, 120 Hz.

The lighting arrangement 10 can, for example, be part of a projector, a beamer or another device in which high luminous densities are advantageous.

The segments 20 have, for example, phosphor coatings or ceramic or crystal segments in which phosphors are embedded or incorporated. The phosphor used can in various embodiments be a phosphor mixture which has a mixture of different phosphors, by which means, for example, light which combines a plurality of different colors can be generated. Suitable phosphors are known in the related art. Common phosphors are, for example, garnets, silicates, nitrides, oxides, phosphates, borates, oxynitrides, sulfides, selenides and halides of aluminum, silicon, magnesium, calcium, barium, strontium, zinc, cadmium, manganese, indium or tungsten and other transition metals, or rare earth metals such as yttrium, gadolinium or lanthanum, which are doped with an activator, such as copper, silver, aluminum, manganese, zinc, tin, lead, cerium, terbium, titanium, antimony or europium. In various embodiments of the disclosure, the phosphor is an oxidic or (oxi-)nitridic phosphor, such as a garnet, orthosilicate, nitride (alumino)silicate or nitridoorthosilcate, or a halide or halophosphate. Practical examples of suitable phosphors are strontium chloroapatite: Eu((sr,Ca)₅(PO₄)₃Ca:Eu; SCAP), yttrium-aluminum garnet: Cer(YAG:Ce) or CaAlSiN₃:Eu. Furthermore, for example, particles having light-scattering properties and/or additives can be contained in the phosphor or phosphor mixture. Examples of additives include surfactants and organic solvents. Examples of light-scattering particles are gold-, silver- and metal oxide particles. Irrespective of this, the phosphor segment can have a matrix material which, for example can have diamond or Al₂O₃. If the segments 20 are completely or partly formed from a crystal, these crystals can be single crystals. Furthermore, the phosphor used can be exclusively phosphorus, for example in different combinations with other substances, wherein it is then possible to use a light source 12 which generates very shortwave light.

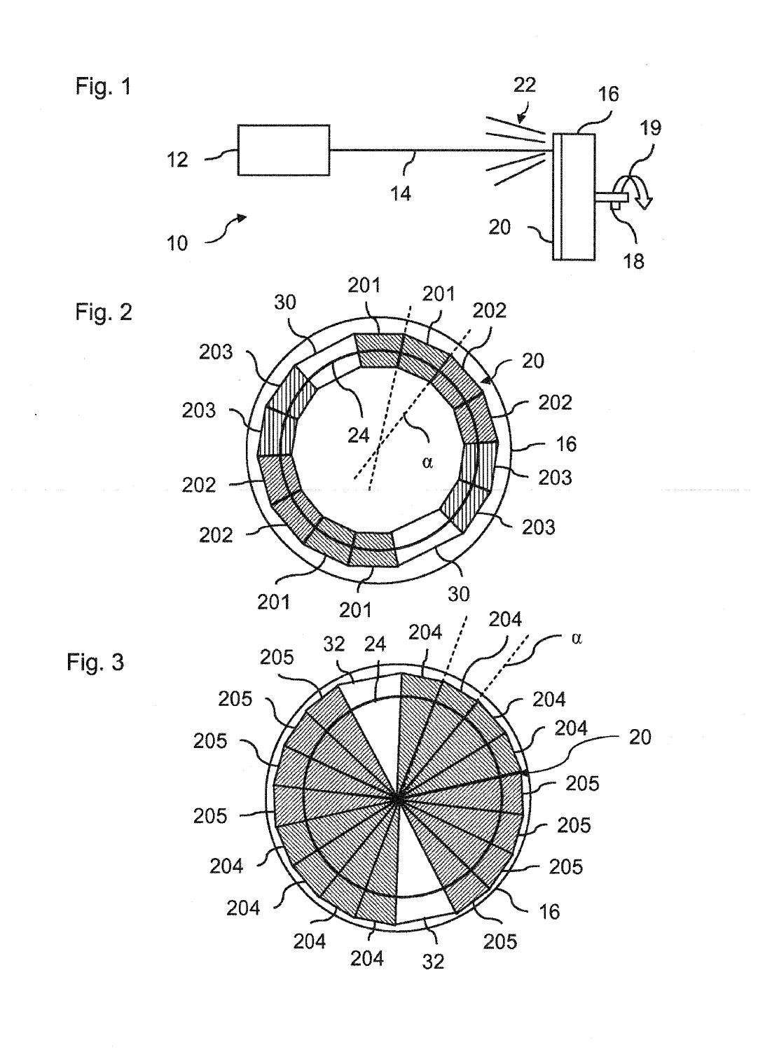

FIG. 2 shows a plan view of the phosphor wheel as seen from the light source 12. On the carrier 16, a multiplicity of individual segments 20 having phosphor is applied and joined together. In particular, segments 201 of a first group, segments 202 of a second group and segments 203 of a third group are arranged circularly or annularly on the carrier 16. The segments 20 of one of the groups, arranged beside one another on the carrier 16, can also be designated as a phosphor section. Thus the segments 201 of the first group, arranged beside one another, form a first phosphor section on the carrier 16, the segments 202 of the second group form a second phosphor section, and the segments 203 of the third group form a third phosphor section. In addition, reflective segments 30, which complete the circular shape or annular shape and form two reflective sections, are arranged on the carrier. The segments 201 of the first group have a first phosphor which, when excited with the aid of the light beam 14, emits light of a first color. The segments 202 of the second group have a second phosphor which, when excited with the aid of the light beam 14, emits light of a second color. The segments 203 of the third group have a third phosphor which, when excited with the aid of the light beam 14, emits light of a third color. When irradiated, the reflective segments reflect the light from the light source 12, which can be white or colored, for example blue, so that the reflected light can accordingly be white or colored, in particular blue. For example, the first color can be red, the second color green and the third color blue, by which means an RGB color space can be represented. Alternatively, with the aid of the color wheel, in particular of the suitable phosphors and of the suitable light source 12, the colors cyan, magenta and yellow can be generated.

The segments 20 are, for example, polygonal, for example trapezoidal. A central angle α of the segments, that is to say the angle enclosed by the mutually inclined sides of the trapezoid in their extension, can lie in an angular range between 3° and 45°, in particular between 5° and 15° and, for example, be 6°. A width and height of the segments 20 depends on the size of the carrier 16, on the placement on the carrier 16, on the central angle and on the number of segments per carrier 16. The width can here, for example, be between 3 mm and 10 mm or between 1 mm and 25 mm, and the height can be, for example, between 5 mm and 10 mm or between 1 mm and 50 mm. The width of the longer parallel sides of the trapezoidal segments 20 can be 3.14 mm, for example, given a central angle of 6° and a phosphor wheel diameter of 33 mm.

To a first approximation, the segments 201, 202, 203 joined together, together with the reflective segments 30, form a closed ring, which has a closed ring surface. As an alternative to this, the segments 201, 202, 203 joined together and/or the reflective segments 30 can form only one or more segments of a ring. On the ring surface there runs a circular path 24, which is representative of a line swept over by the light beam 14 when the phosphor wheel rotates. A segment of the circular path 24 extends over several of the segments 20. The segments 20 are preferably formed, with respect to their geometric shape and size, such that the circular path 24 lies completely within the ring surface, a diameter of the light beam 14 preferably also being taken into account. In other words, the dimensions of the segments 20 can be chosen as a function of the size of the phosphor wheel, the radius of the circular path 24 and/or the beam diameter of the light beam 14, for example in such a way that the light beam 14 runs over the segments 20 and/or the reflective segments 30 at every time during operation.

FIG. 3 shows the phosphor wheel according to various embodiments, wherein the segments 20 are triangular, for example. Furthermore, as distinct from the phosphor wheel shown in FIG. 2, only segments 204 of a fourth group and segments 205 of a fifth group, that is to say two different groups, which accordingly have two different light-generating phosphors, are arranged. As an alternative to this, also in accordance with the phosphor wheel shown in FIG. 2, light of three different colors can be generated by using corresponding groups of segments 20. The segments 204, 205 of the fourth and fifth group, together with triangular reflective segments 32, approximately form a closed circular area. The circular path 24 runs completely within this circular area.

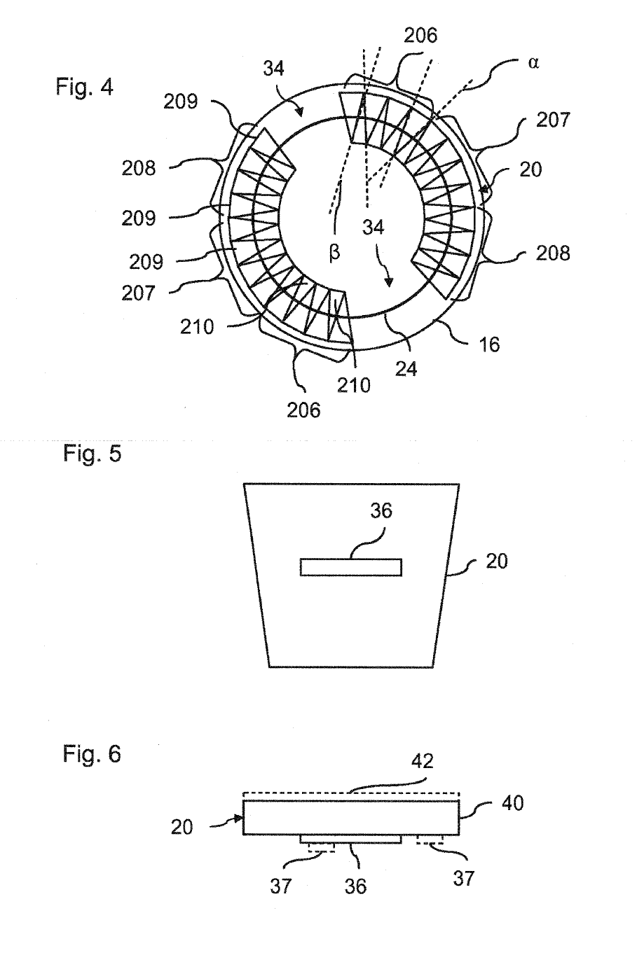

FIG. 4 shows the phosphor wheel according to various embodiments, wherein segments 209, 210 are triangular and wherein two geometric types of segments 209, 210 are arranged. The two different types of segments 209, 210 form a plurality of phosphor segments on the carrier 16 and, with respect to the color of the light which can be generated with their help, are produced from a sixth group 206, a seventh group 207 and an eighth group 208 of segments 209, 210, corresponding to three different light colors. With respect to their geometric shape, all the outer segments 209, the base of which is located on the outside of the carrier 16, are formed identically and differ with respect to the geometric shape from all the inner segments 210, of which the base is located on the inside of the carrier 16. In particular, the inner segments 210 are formed smaller than the outer segments 209. Furthermore, the inner and outer segments 210, 209 differ with respect to the angle which lies opposite their respective base. Thus, the central angle α of the segments 209 located on the outside is not equal to a further central angle β of the segments 210 located on the inside. The segments 209, 210 are formed and joined together such that they form at least segments of a ring. Reflective segments 34 can be formed, for example, by the carrier 16 itself acting reflectively, so that in the appropriate regions, simply no segments, in particular segments 20, are applied to the carrier 16. Alternatively, reflective segments 30, 32 can be arranged.

FIG. 5 shows a view of an underside of one of the trapezoidal segments 20 according to various embodiments. The underside of the phosphor segment 20 faces the carrier 16 on the carrier 16. Alternatively, the phosphor segment 20 can have a different shape and, for example, can be triangular. On the underside, the phosphor segment has an elevation 36. The elevation 36 is formed in the shape of a cube, for example. Alternatively, the elevation 36 can be cylindrical, for example. Furthermore, a plurality or more complicatedly shaped elevations 36 can also be formed on the phosphor segment 20.

FIG. 6 shows a side view of the phosphor segment 20 according to FIG. 5. The phosphor segment 20 has a substrate segment 40, which is coated with a phosphor layer 42 having the phosphor. A thickness of the substrate segment 40 is, for example, less than or equal to 100 μm, less than or equal to 50 μm or less than or equal to 10 μm. Alternatively, the phosphor segment 20 may include ceramic or crystal or be formed therefrom, wherein the phosphor can then be embedded in the ceramic or incorporated in the crystal structure of the crystal and/or the phosphor layer 42 can be omitted. On the underside, the phosphor segment 20 is at least partly coated with a metal layer 37, for example on the elevation 36 and/or outside the elevation 36. Alternatively or additionally, the substrate segment 40 can be formed from metal, for example from tungsten, and/or comprise metal on its underside. The metal layer 37 or the substrate segment 40 can, for example, have aluminum, in particular reflective or highly reflective aluminum, chromium or copper or consist thereof. For example, a substrate segment 40 made of aluminum can be coated with copper on its underside in a galvanic coating process and/or can be formed to be highly reflective on an upper side located opposite the underside. The metal and the metal layer 37 on the underside contribute to good thermal coupling of the phosphor segment 20 to the carrier 16. In addition, the metal and the metal layer 37 enable the phosphor segment 20 to be soldered firmly to the carrier 16. For example, tin solder can be applied to the metal layer 37 and the carrier 16, the segments 20 can be joined together on the carrier 16 and then the carrier 16, together with the segments 20, can be heated in such a way that the tin solder melts and connects the segments 20 firmly to the carrier 16. In addition or alternatively, the segments 20 can also be firmly adhesively bonded to the carrier 16 and/or they can be at least partly in bodily contact with the carrier 16. For example, tin solder can be applied only in the region of the elevation 36, and the bodily contact can be produced outside the elevation.

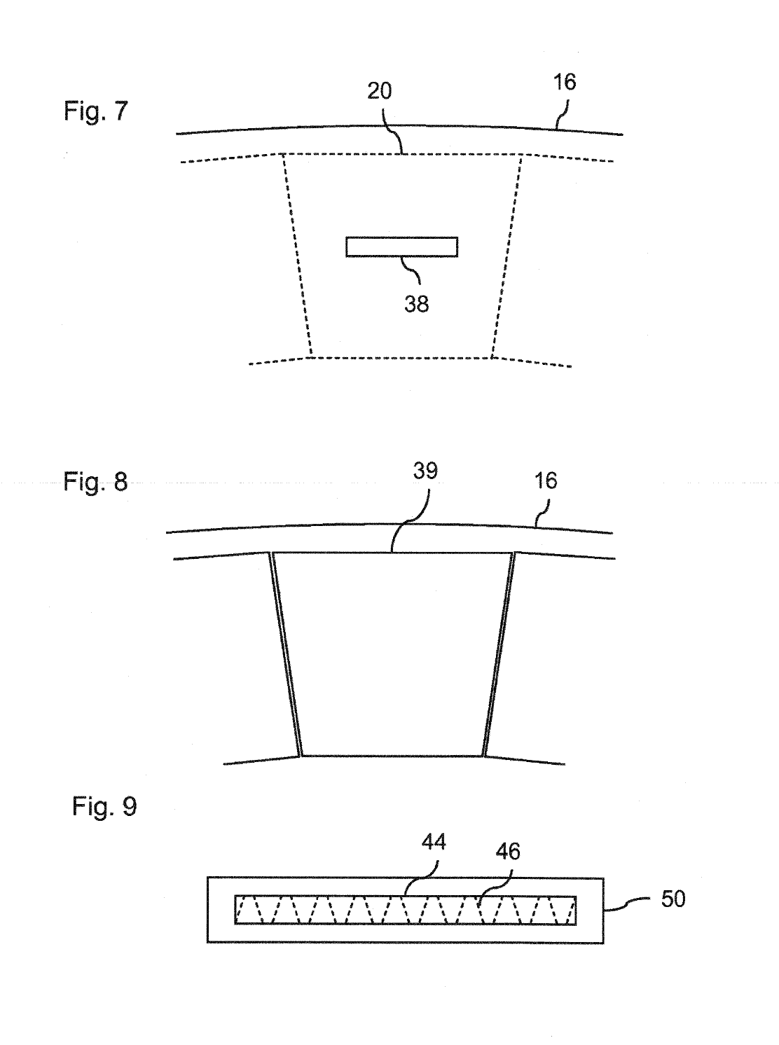

FIG. 7 shows a detail of the carrier 16 according to various embodiments, on which the segments 20 to be arranged are indicated dashed. The carrier has a recess 38, which corresponds to the elevation 36 of the phosphor segment 20. If the phosphor segment 20 is arranged as intended, then the elevation 36 of the phosphor segment 20 is located in the recess 38 in the carrier 16. It can then contribute to arranging the segments 20 quickly, precisely and simply on the carrier 16. As an alternative to this, a plurality of appropriate elevations 36 and recesses 38 corresponding thereto can also be provided. Furthermore, alternatively or additionally, recesses which correspond to elevations on the carrier 16 can be provided on the segments. Furthermore, the recesses 38 and elevations 36 can also be provided in geometrically differently shaped segments 20, for example in triangular ones.

FIG. 8 shows a detail of the carrier 16 according to various embodiments, which has a receptacle 39 to receive the segments 20. The dimensions of the receptacle correspond to the dimensions of the segments 20 in such a way that in each case a phosphor segment 20 can simply be laid in the receptacle 39 but can no longer slide laterally. For example, the segments 20 can be formed with a clearance fit in relation to the corresponding receptacle 39. The receptacles 39 can be formed additionally or alternatively to the elevations 36 and recesses 38. Furthermore, the receptacles 39 can also be provided in geometrically differently shaped segments 20, for example in triangular ones.

FIG. 9 shows a piece of material 44 on a holding body 50 in a production process for producing the segments 20 according to various embodiments. The piece of material 44 is, for example, a piece of substrate, a piece of ceramic or a piece of crystal and can be formed in the manner of a strip, for example. For example, the piece of material 44 can be a section of an endless strip and/or have aluminum foil. The piece of material is connected to the holding body 50 and is held by the latter. The connection is preferably such that it is detachable without destroying the holding body 50 or the piece of material 44. For example, the piece of material 44 is firmly adhesively bonded to the holding body 50 with the aid of a thermal release adhesive. This connection can then be detached simply by heating the holding body 50 and the piece of material 44. Before the detachment of the piece of material 44 from the holding body 50, the piece of material 44 is sawn or cut along predefined cut edges 46, wherein the segments produced as a result, in particular the substrate segments 40, the ceramic segments or crystal segments, continue to cohere via the holding body 50. The sawing or cutting of the piece of material 44 can be carried out, for example, with the aid of a laser or in an etching process, preference being given to cutting processes in which the cut is relatively narrow and thus as little cutting waste as possible arises. The substrate segments can be coated with the phosphor layer 42 following the cutting on the holding body 50 and then separated, by being detached from the holding body 50. Cutting the substrate segments 40 first and then coating them contributes to the phosphor layer 42 not being damaged by the cutting process. As an alternative to this, the substrate segments 40 can also be coated first and then cut. If the segments 20 have the ceramic having phosphor or the crystal having phosphor, the segments 20 can also be separated without coating. The piece of material 44 is illustrated in FIG. 9 as only so high that only one row of segments can be cut out therefrom. As an alternative to this, the piece of material 44 can also be provided as so high that several rows of segments can be cut out therefrom. The height of the holding body 50 can then be adapted appropriately.

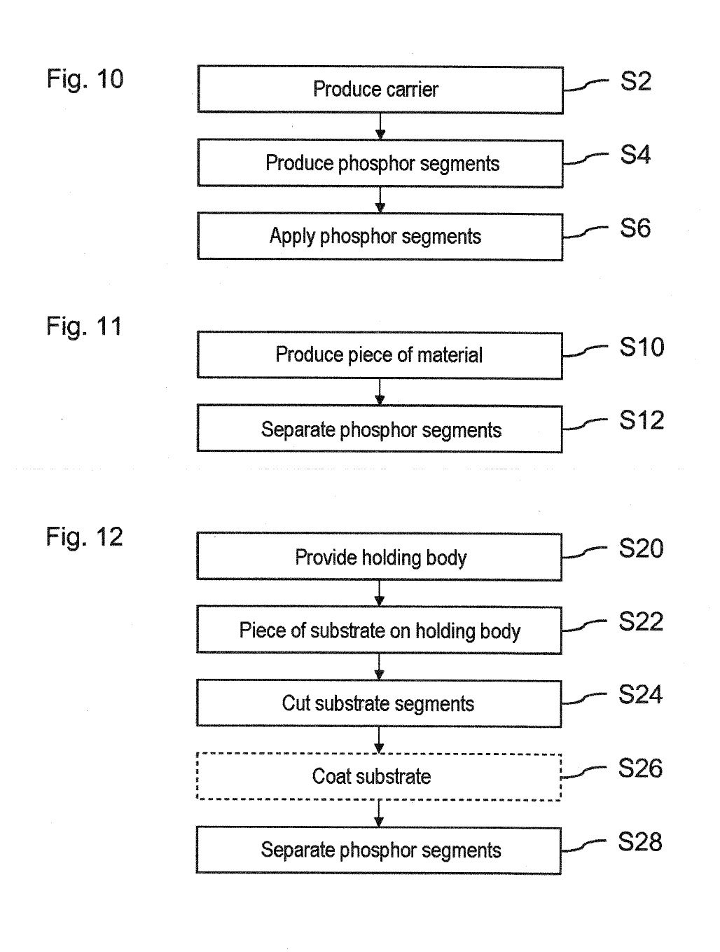

FIG. 10 shows a flowchart of a method for producing the phosphor wheel according to various exemplary embodiments.

In a step S2, the carrier 16 is produced. The carrier 16 can be produced from copper, for example, or have copper. The carrier 16 can, for example, be formed circularly or annularly and/or have spokes. Furthermore, the carrier 16 can be provided with one or more cooling devices such as, for example, cooling ribs or cooling channels for a cooling medium.

In a step S4, the segments 20 are produced. The production is carried out, for example, by providing and machining the piece of material 44 and, for example, with the aid of the holding body 50. For example, a plurality of pieces of material 44 which each have different phosphors can be produced. For example, it is possible to produce at least three pieces of material 44 which have phosphors with which, accordingly, it is possible to produce three different groups of segments 20 with the aid of which, accordingly, three different colors can be generated. Following the separation of the segments 20, segments 20 of all three pieces of material 44 and groups can then be applied to a phosphor wheel, with the aid of which light of three colors can then be generated in the lighting arrangement 10. The number of different colors and groups and therefore different pieces of material 44 for a phosphor wheel, and the number and color selection of the segments 20 for a phosphor wheel can be selected individually on the basis of the lighting arrangement 10 for which the phosphor wheel is provided and/or on the basis of the application for which the lighting arrangement 10 is envisaged. With the aid of the segments 20 of the three pieces of material 44, two or more phosphor wheels can also be equipped. For instance, in mass production the segments 20 of different groups can be produced independently of the subsequent application and stored and then, at a later time, be selected for individual applications, assembled and then joined together on one or more of the carriers 16, which means that the appropriate phosphor wheels can be produced simply and economically.

In a step S6, the segments 20 are applied to the carrier 16, the segments 20 being joined together on the carrier 16 and affixed thereto, for example with the aid of the recesses 38, the elevations 36, the receptacles 39 and/or with the aid of tin solder, for example in a reflow soldering process, or adhesive. The segments 20 can be polygonal, in particular triangular, square or trapezoidal or have another suitable shape.

FIG. 11 shows a method for producing the segments 20 according to various embodiments, wherein this method can be performed, for example, as step S4 of the method shown in FIG. 10.

In a step S10, the piece of material 44 is produced. For example, the piece of material 44 is formed from a ceramic having the phosphor and is produced in a sintering process, for example. As an alternative to this, the piece of material 44 can, for example, have a crystal having the phosphor or consist thereof and, for example in an appropriate growth process, can be grown on a piece of substrate or directly on the holding body 50. In this connection, the metal layer 37 can be vapor-deposited on an underside of the piece of material 44, for example a chromium layer and/or copper layer, in order that the segments 20 made of ceramic or crystal can subsequently be fixed to the carrier 16, for example by means of soldering.

In a step S12, the segments 20 are separated from the piece of material 44, wherein the piece of material 44 can be supported by the holding body 50 or not, depending on stability of the piece of material 44. In this connection, the piece of material 44 can be formed, for example, from ceramic having the phosphor or from crystal having the phosphor.

FIG. 12 shows a method for producing the segments 20 according to various embodiments, wherein this method can be performed, for example, as step S4 of the method shown in FIG. 10.

In a step S20, the holding body 50 is provided. The holding body 50 is, for example, relatively stable and wears as little as possible during the subsequent cutting process. The holding body 50 can be formed in such a way, for example, that it can be re-used.

In a step S22, a piece of substrate is arranged on the holding body 50 as the piece of material 44. The piece of substrate consists, for example, of an aluminum strip, which is severed from an endless aluminum strip. The piece of substrate is fixed detachably to the holding body 50 and is cut along the cutting lines 46 on the holding body 50. As an alternative to this, the cutting lines can run differently, for example such that triangular segments are produced.

In a step S24, the substrate segments 40 on the holding body 50 are optionally coated with the phosphor layer 42, wherein the substrate segments 40 can, for example, be designed to be reflective, for example by using highly reflective aluminum, and wherein the substrate segments 40 do not have to be coated in order to produce the reflective segments 30, 32. The segments 20 can be coated by means of printing processes, doctoring processes or tape casting. The area to be coated is, for example, straight or planar and can be treated appropriately before the coating, for example in order that the phosphor layer 42 is more homogeneous or adheres better to the piece of substrate. Following the coating, the phosphor layer 42 can be dried, baked and/or hardened.

In a step S28, the cut and coated substrate segments 40 are detached from the holding body 50 and separated as a result, which produces the individual segments 20.

The disclosure is not restricted to the exemplary embodiments indicated. For example, the segments 20 can have different geometric shapes and/or be arranged and/or fixed differently on the carrier 16. Furthermore, the segments 20 can have other or further materials and/or be produced in another way. For example, the methods shown can have alternative or additional steps, for example for finishing the segments 20.

### LIST OF DESIGNATIONS

10 Lighting arrangement
12 Light source
14 Light beam
16 Carrier
18 Shaft
19 Direction of rotation
20 Segments
201 First segment group
202 Second segment group
203 Third segment group
204 Fourth segment group
205 Fifth segment group
206 Sixth group
207 Seventh group
208 Eighth group
209 Outer segments
210 Inner segments
22 Light beams
24 Circular path
30 Reflective segments
32 Triangular reflective segments
36 Elevation
37 Metal layer
38 Recess
39 Receptacle
40 Substrate segment
42 Phosphor layer
44 piece of material
46 Cutting edges
50 Holding body
α Central angle
β Further central angle
S2-S28 Steps 2 to 28

1. A phosphor wheel, comprising:
a carrier; and
a multiplicity of individual segments which are prefabricated, joined together and applied to the carrier;
at least some of the segments having phosphor.

2. The phosphor wheel as claimed in claim 1, wherein the segments are formed and joined together such that at least one segment of a circular path extends over a plurality of adjacent segments.

3. The phosphor wheel as claimed in claim 2, wherein the segments have a polygonal structure.

4. The phosphor wheel as claimed in claim 3, wherein the segments have a triangular or a trapezoidal structure.

5. The phosphor wheel as claimed in claim 1, wherein the segments joined together form at least one segment of a ring.

6. The phosphor wheel as claimed in claim 1, wherein a first group of the segments has a first phosphor, which is suitable to generate light of a first color, and wherein a second group of the segments has a second phosphor, which is suitable to generate light of a second color, which differs from the first color.

7. The phosphor wheel as claimed in claim 6, wherein a third group of the segments has a third phosphor, which is suitable to generate light of a third color, which differs from the first and second color.

8. The phosphor wheel as claimed in claim 6, in which a fourth group of segments is designed to be reflective.

9. The phosphor wheel as claimed in claim 1, wherein the segments each have a substrate segment, which is coated with a phosphor layer having the phosphor.

10. The phosphor wheel as claimed in claim 1, wherein the segments have a ceramic, wherein the phosphor is embedded, or are formed therefrom.

11. The phosphor wheel as claimed in claim 1, wherein the segments have a crystal, in the crystal structure of which the phosphor is incorporated, or are formed therefrom.

12. The phosphor wheel as claimed in claim 1, wherein the segments have recesses or elevations of the segments and the carrier has elevations or recesses of the carrier corresponding thereto, so that the elevations of the carrier are arranged in the recesses of the segments or, respectively, the elevations of the segments are arranged in the recesses of the carrier.

13. The phosphor wheel as claim 1, wherein the carrier has receptacles for the segments and the segments are at least partly arranged in the receptacles.

14. A method for producing a phosphor wheel, the method comprising:
producing a carrier;
producing a multiplicity of individual segments, at least some of the segments having phosphor; and
applying the segments to the carrier and joining together.

15. The method as claimed in claim 14, wherein a piece of material is provided and the plurality of the segments is separated from the one piece of material.

16. The method as claimed in claim 15, wherein the piece of material has a piece of substrate which, before the separation of the segments, is coated with a phosphor layer having the phosphor.

17. The method as claimed in claim 16, wherein the piece of substrate is first applied to a holding body and then sawn or cut such that individual substrate segments continue to cohere via the holding body following the sawing or cutting and in which, subsequently, the substrate segments are coated with the phosphor layer and the coated substrate segments are detached from the holding body and separated as a result.

18. The method as claimed in claim 15, wherein the piece of material having the phosphor before the separation or the individual segments after the separation is/are coated with a metal layer, at least on one side.

19. The method as claimed in claim 18, wherein the segments are fixed to the carrier via the metal layer.

20. The method as claimed in claim 19, wherein the metal layers of the segments are firmly soldered to the carrier.

21. The method as claimed in claim 14, wherein the segments are firmly adhesively bonded to the carrier.

22. A lighting arrangement comprising a phosphor wheel and having an excitation source which irradiates the segments selectively,
the phosphor wheel comprising:
a carrier; and
a multiplicity of individual segments which are prefabricated, joined together and applied to the carrier;
at least some of the segments having phosphor.
